(19) United States
(12) Patent Application Publication
(10) Pub. No.: US 2026/0228553 A1
(43) Pub. Date: Aug. 6, 2026

(54) SYSTEMS AND METHODS FOR ROBUST UNLEARNING TO REMOVE KNOWLEDGE IN THE NEIGHBOR OF FORGET SAMPLES

(71) Applicant: JPMORGAN CHASE BANK, N.A., New York, NY (US)

(72) Inventors: Hsiang HSU, Boston, MA (US); Pradeep NIROULA, College Park, MD (US); Zichang HE, Jersey City, NJ (US); Richard CHEN, Baldwin Place, NY (US)

(21) Appl. No.: 19/042,612

(22) Filed: Jan. 31, 2025

(51) Int. Cl. G06N 3/094; G06F 17/11

(52) U.S. Cl. CPC G06N 3/094; G06F 17/11

(57) ABSTRACT

A method for robust unlearning to remove knowledge in the neighbor of forget samples include: receiving retain samples and forget samples; computing an adversarial forget sample corresponding to each forget sample, a first loss function term for each retain sample based on a corresponding retain sample label and a predicted retain sample label by an unlearned model, and a second loss function term for each forget sample based on a predicted label for its adversarial forget sample and a random label; solving for a minimization of weights using the first loss function term, the second loss function term, and a L2 norm for the trained machine learning model and an unlearned model; and updating the unlearned model using weights resulting from the minimization; where the unlearned model does not include information for the adversarial forget samples and maintains information from the retain samples.

### BACKGROUND OF THE INVENTION

### 1. Field of the Invention

Embodiments generally relate to systems and methods for robust unlearning to remove knowledge in the neighbor of forget samples.

### 2. Description of the Related Art

Unlearning algorithms are a class of machine learning techniques designed to effectively erase the learned knowledge of specific “forget” samples from a model. While current unlearning algorithms can successfully remove the knowledge associated with a forget sample, they often struggle to eliminate the knowledge in the vicinity of that sample. In other words, even after a forget sample has been unlearned from a machine learning model, a slight perturbation of the forget sample might still lead the model to recognize it again, indicating a failure in the unlearning process. This poses a potential privacy risk for existing unlearning algorithms.

### SUMMARY OF THE INVENTION

Systems and methods for robust unlearning to remove knowledge in the neighbor of forget samples are disclosed. According to an embodiment, a method may include: (1) receiving, by an unlearning computer program executed by an electronic device, a plurality of retain samples and a plurality of forget samples to unlearn from a trained machine learning model; (2) computing, by the unlearning computer program, an adversarial forget sample corresponding to each forget sample; (3) computing, by the unlearning computer program, a first loss function term for each retain sample based on a corresponding retain sample label and a predicted retain sample label by an unlearned model; (4) computing, by the unlearning computer program, a second loss function term for each forget sample based on a predicted label for its adversarial forget sample and a random label; (5) computing, by the unlearning computer program, a L2 norm for the trained machine learning model and an unlearned model; (6) solving, by the unlearning computer program, for a minimization of weights using the first loss function term, the second loss function term, and the L2 norm; (7) updating, by the unlearning computer program, the unlearned model using weights resulting from the minimization; and (8) deploying, by the unlearning computer program, the unlearned model to a production environment, where the unlearned model does not include information for the adversarial forget samples and maintains information from the retain samples.

The method of claim 1, wherein the trained machine learning model and the unlearned model return the same label for the forget sample and its corresponding adversarial forget sample, and the unlearned model outputs an incorrect label for the forget sample and corresponding adversarial forget sample.

In one embodiment, a difference between the forget sample and the adversarial forget sample is less than a threshold.

In one embodiment, the random label is selected from a discrete uniform distribution of labels.

In one embodiment, the L2 norm comprises a square root of a sum of squares of a difference of all weights between the trained machine learning model and the unlearned model.

In one embodiment, the minimization is solved using stochastic gradient decent.

According to another embodiment, a system may include: a database comprising a plurality of retain samples and a plurality of forget samples; an electronic device comprising a computer processor executing an unlearning computer program; and a downstream system in a production environment. The unlearning computer program receives the set of retain samples and the set of forget samples from the database; the unlearning computer program computes an adversarial forget sample corresponding to each forget sample; the unlearning computer program computes a first loss function term for each retain sample based on a corresponding retain sample label and a predicted retain sample label by an unlearned model; the unlearning computer program computes a second loss function term for each forget sample based on a predicted label for its adversarial forget sample and a random label; the unlearning computer program computes a L2 norm for the trained machine learning model and an unlearned model; the unlearning computer program solves for a minimization of weights using the first loss function term, the second loss function term, and the L2 norm; the unlearning computer program updates the unlearned model using weights resulting from the minimization; and the unlearning computer program deploys the unlearned model to the downstream system in the production environment, where the unlearned model does not include information for the adversarial forget samples and maintains information from the retain samples.

In one embodiment, the trained machine learning model and the unlearned model return the same label for the forget sample and its corresponding adversarial forget sample, and the unlearned model outputs an incorrect label for the forget sample and corresponding adversarial forget sample.

In one embodiment, a difference between the forget sample and the adversarial forget sample is less than a threshold.

In one embodiment, the random label is selected from a discrete uniform distribution of labels.

In one embodiment, the L2 norm comprises a square root of a sum of squares of a difference of all weights between the trained machine learning model and the unlearned model.

In one embodiment, the minimization is solved using stochastic gradient decent.

According to another embodiment, a non-transitory computer readable storage medium may include instructions stored thereon, which when read and executed by one or more computer processors, cause the one or more computer processors to perform steps comprising: receiving a plurality of retain samples and a plurality of forget samples to unlearn from a trained machine learning model; computing an adversarial forget sample corresponding to each forget sample; computing a first loss function term for each retain sample based on a corresponding retain sample label and a predicted retain sample label by an unlearned model; computing a second loss function term for each forget sample based on a predicted label for its adversarial forget sample and a random label; computing a L2 norm for the trained machine learning model and an unlearned model; solving for a minimization of weights using the first loss function term, the second loss function term, and the L2 norm; updating the unlearned model using weights resulting from the minimization; and deploying the unlearned model to a production environment, where the unlearned model does not include information for the adversarial forget samples and maintains information from the retain samples.

In one embodiment, the trained machine learning model and the unlearned model return the same label for the forget sample and its corresponding adversarial forget sample, and the unlearned model outputs an incorrect label for the forget sample and corresponding adversarial forget sample.

In one embodiment, a difference between the forget sample and the adversarial forget sample is less than a threshold.

In one embodiment, the random label is selected from a discrete uniform distribution of labels.

In one embodiment, the L2 norm comprises a square root of a sum of squares of a difference of all weights between the trained machine learning model and the unlearned model.

In one embodiment, the minimization is solved using stochastic gradient decent.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for robust unlearning to remove knowledge in the neighbor of forget samples according to an embodiment;

FIG. 2 depicts a method for robust unlearning to remove knowledge in the neighbor of forget samples according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for robust unlearning to remove knowledge in the neighbor of forget samples.

Embodiments may provide a computationally efficient frameworks that mitigate the risk of re-identification of forget samples through slight perturbations. This significantly enhances privacy protection. Embodiments not only close the loopholes present in traditional unlearning methods but also provide a robust safeguard against potential privacy leaks. The integration of adversarial training ensures that the framework is both resilient and adaptable, making it a valuable tool for maintaining data privacy in machine learning models.

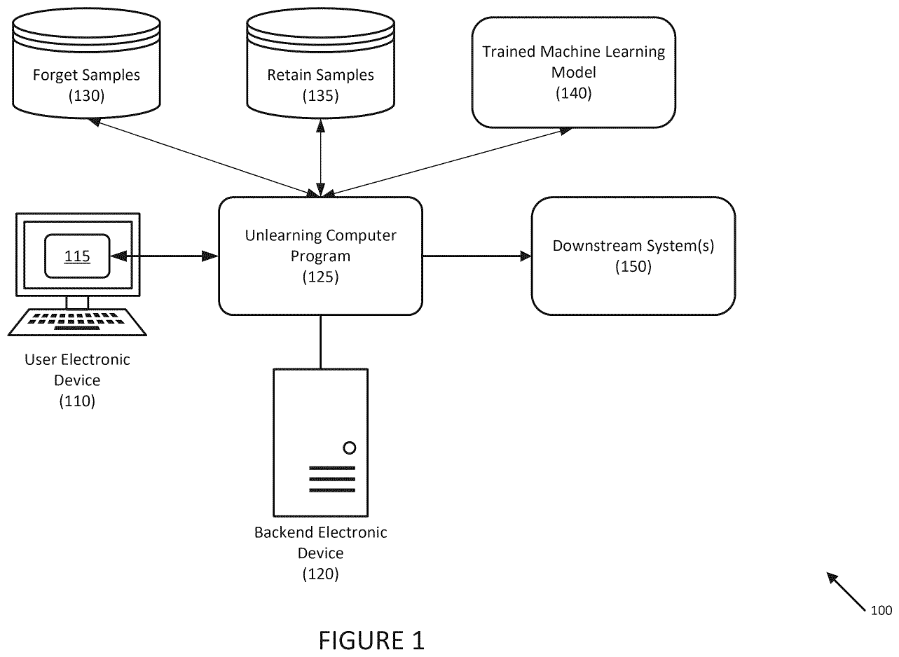

Referring to FIG. 1, a system for robust unlearning to remove knowledge in the neighbor of forget samples is disclosed according to an embodiment. System 100 may include user electronic device 110, which may be a computer (e.g., workstation, desktop, laptop, notebook, etc.), a smart phone, a smart watch, an Internet of Things (IoT) appliance, etc. User electronic device 110 may execute user computer program 115, which may be an application, a browser, etc.

In one embodiment, user computer program 115 may provide a set of forget samples 130 and a set of retain samples 135 that may be used to unlearn model 140, such as a machine learning model.

Set of forget samples 130 and set of retain samples may include a plurality of samples, such as images, audio, combinations, etc. Set of forget samples 130 are samples that include a feature that trained machine learning model 140 is to forget and set of retain samples include features that trained machine learning engine 140 is to retain.

System 100 may also include backend electronic device 120, which may be a server (e.g., physical and/or cloud-based), a computer, etc. Backend electronic device 120 may execute unlearning computer program 125 that may process set of forget samples 130 and set of retain samples 135 to update trained machine learning model 140 to forget features in set of forget samples.

Downstream system 150 may be any system or device that may use trained machine learning model 140. Once trained machine learning model 140 is updated to forget the features in set of forget samples 130, the set of forget samples 130 cannot be re-identified.

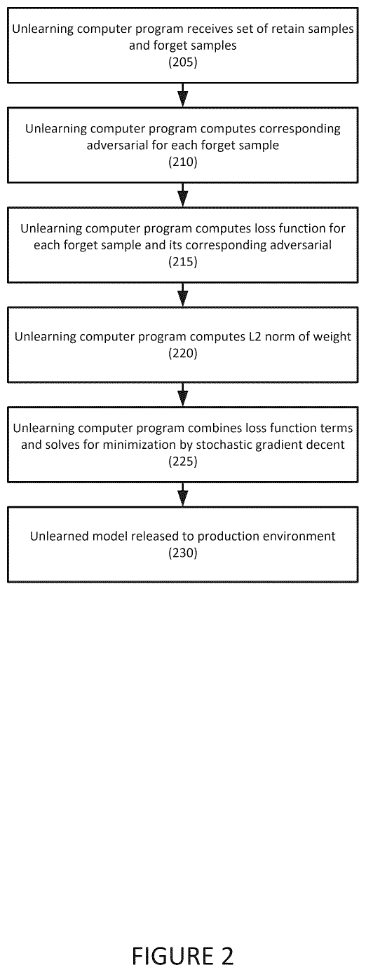

Referring to FIG. 2, a method for robust unlearning to remove knowledge in the neighbor of forget samples is disclosed according to an embodiment.

In step 205, an unlearning computer program may receive a set of retain samples and a set of forget samples to be used to unlearn from trained machine learning model. In one embodiment, the set of retain samples and the set of forget samples may be provided by a user.

The retain samples and the forget samples may be image samples, audio samples, combinations, etc.

The user may also provide a regularization strength hyper-parameter. The regularization strength controls how far the unlearned model is from the original machine learning model. Ideally, the unlearned model should not be too different from the original machine learning model. The value of the regularization hyper-parameter may be set case by case.

The user may also provide a fine-tuning parameter that controls the relative strength between fine-tuning on the retain samples and unlearning the neighboring of forget samples.

In step 210, the unlearning computer program may compute a corresponding adversarial forget sample for each forget sample. For example, for a trained machine learning model given a forget sample x_{f} and its label, y_{f}, the unlearned model is not able to correctly identify the label y_{f}. In other words, the trained model returns label y_{f}, but the unlearned model does not return label y_{f}. The adversarial forget sample

$${x}_{f}^{′}$$

of forget sample x_{f} is a sample that is very similar to forget sample x_{f}, such that both the trained model and the unlearned model return label y_{f}; in other words, unlearning does not work on the adversarial forget sample

$${x}_{f}^{′}$$

because the adversarial forget sample

$${x}_{f}^{′}$$

carries residual information about the correct class, which is undesirable.

Given a numeric forget sample x_{f}, the adversarial forget sample

$${x}_{f}^{′}$$

is the solution of the following optimization problem:

$${x}_{f}^{′} = arg {min}_{\{ x in X \}} loss ( {f}_{θ} ( {x}_{f}^{′} ) , y ) such that ‖ {x}_{f} - {x}_{f}^{′} ‖ \leq t$$

For example, the optimization problem seeks to find an adversarial forget sample that is very similar to x (i.e., controlled by

$$‖ {x}_{f} - {x}_{f}^{′} ‖ \leq t ) ,$$

such that the output of the unlearned model, f_{θ}, such as a machine learning model, will be a given label y_{f} for the adversarial forget sample

$${x}_{f}^{′} ,$$

and t is a threshold hyperparameter.

The threshold hyperparameter, t, may be specified by the user and based on the user's needs. For example, a larger value of t removes more residual information around the forget sample. This, however, cause the model to unlearn more and hence lowers the performance. A value of 0 does not consider the residual knowledge, which effectively degenerates to existing unlearning methods that do not consider the residual information.

Label y_{f} may be provided in the forget dataset, or it may be provided by the user.

In step 215, the unlearning computer program may compute loss function terms. For example, a first loss function term may be based on the predicted label of the unlearned machine model for retain sample xᵣ and the label for the retain sample yᵣ from the dataset.

The loss function may be the cross-entropy loss.

An example of the first loss function term is:

$${\sum }_{( x , y ) ∈ {D}_{r}} ℓ ( {f}_{θ} ( x ) , y )$$

A second loss function term may be based on the predicted label of the unlearned machine model for each adversarial forget sample

$${x}_{f}^{′}$$

and a random label y. Given a forget sample x_{f} and its forget label y_{f}, the forget label y_{f} is used to produce the adversarial forget sample

$${x}_{f}^{′}$$

(which still has residual knowledge). For example, for forget sample x_{f} and its label y_{f}=0 (where the labels are 0, 1, 2, 3, or 4), even after unlearning, an adversarial sample,

$${x}_{f}^{′}$$

exists such that the output of f_{θ}=0, which is not desired.

When training the unlearned model, the adversarial forget sample

$${x}_{f}^{′}$$

is associated with a random label y to force the unlearned model to forget the residual knowledge. For example, a random label may be selected from a discrete uniform distribution of labels, and the unlearned model is forced to output the random label instead. This will make sure that the samples “around” the forget sample that will be classified correctly (as label 0) will now be classified “randomly”. Therefore, the neighboring of the forget sample results in the incorrect label being output.

An example of the second loss function term is:

$${\sum }_{x ∈ {D}_{f} ; y ∼ uniform ( 1 , c )} {min}_{{x}^{′} ∈ {B}_{q} ( x , ϵ )} ℓ ( {f}_{θ} ( {x}_{f}^{′} ) , y )$$

In step 220, the unlearning computer program may compute a L2 norm

$$( i . e . , {‖ θ - {θ}_{0} ‖}_{2}^{2} ) ,$$

which is the square root of the sum of the squares of the difference of all the weights between the original and unlearned machine learning model. θ₀ represents the initial weights of the trained model f_{θ} and are fixed. θ represents the weights of the unlearned model and may vary for each training step. The L2 norm controls updating θ so that it is not far from the initial weight of the trained model.

In step 225, the unlearning computer program may combine loss function terms and may solve for minimization of the weights in the machine learning model by stochastic gradient decent. For example, the minimization may be solved for with the following equation:

$${min}_{θ} α \frac{1}{{n}_{r}} {\sum }_{( x , y ) ∈ {D}_{r}} ℓ ( {f}_{θ} ( x ) , y ) + ( 1 - α ) \frac{1}{{n}_{f}} {\sum }_{x ∈ {D}_{f} ; y ∼ uniform ( 1 , c )} {min}_{{x}^{′} ∈ {B}_{q} ( x , ϵ )} ℓ ( {f}_{θ} ( {x}_{f}^{′} ) , y ) + \frac{λ}{2} {‖ θ - {θ}_{0} ‖}_{2}^{2}$$

where:
Dᵣ: retain dataset, containing retain samples (information to keep);
nᵣ: number of retain samples;
D_{f}: forget dataset, containing one or more forget samples (information to remove);
n_{f}: number of forget samples n_{f}≥1;
f_{θ}: a machine learning model (e.g., a neural network) with weights θ;
[symbol] : a loss function that compute the loss regarding the output of the neural network f_{θ}(x) and the label y;
B_{q}(x, ϵ): a (l_{q}-norm) ball centered at a forget sample x with radius ϵ, where ϵ can be set by users, i.e., x′ is an adversarial example;
uniform (1, c): a uniform random variable that randomly output an integer between 1 and c, where c is the number of classes. In other words, the label of the x′ is randomized;
θ₀: the original model before unlearning;

$${‖ θ - {θ}_{0} ‖}_{2}^{2} :$$

a regularization term (the L2 norm) that constrains the change of the weight;
λ: the strength of the regularization hyper-parameter that may be set by the user;
α: a fine-tuning hyper-parameter that may be set by the user that controls the relative strength between fine-tuning on the retain samples and unlearning the neighboring of forget samples.

This solves the minimization of the three terms (the first loss function regarding the label yᵣ and the original retain sample (xᵣ), the second loss function regarding the label y_{f} and the adversarial forget sample

$$( {x}_{f}^{′} ) ,$$

and the L2 norm) at once. The minimization provides weights for a model that is not too distant from the original model that does not have information about the adversarial forget samples but maintains the information about the original retain samples.”

In one embodiment, the weights from the minimization may be used to build a new machine learning model that has unlearned the forget samples.

In step 230, after minimization, the machine learning model may be an unlearned model that is robust against the “residual knowledge” and may be released. For example, the unlearned model may be deployed to a production environment.

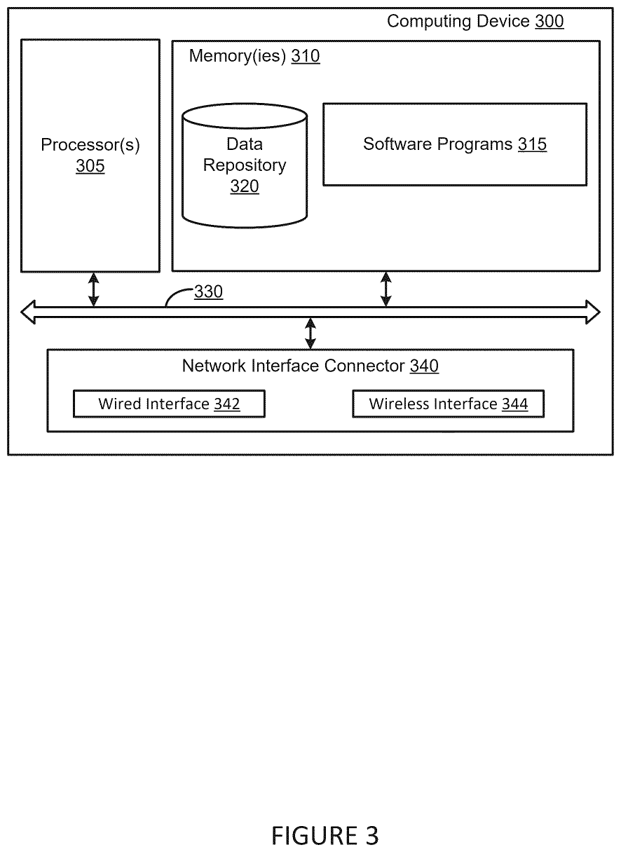

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by an unlearning computer program executed by an electronic device, a plurality of retain samples and a plurality of forget samples to unlearn from a trained machine learning model;
computing, by the unlearning computer program, an adversarial forget sample corresponding to each forget sample;
computing, by the unlearning computer program, a first loss function term for each retain sample based on a corresponding retain sample label and a predicted retain sample label by an unlearned model;
computing, by the unlearning computer program, a second loss function term for each forget sample based on a predicted label for its adversarial forget sample and a random label;
computing, by the unlearning computer program, a L2 norm for the trained machine learning model and the unlearned model;
solving, by the unlearning computer program, for a minimization of weights using the first loss function term, the second loss function term, and the L2 norm;
updating, by the unlearning computer program, the unlearned model using weights resulting from the minimization; and
deploying, by the unlearning computer program, the unlearned model to a production environment, where the unlearned model does not include information for the adversarial forget samples and maintains information from the retain samples.

2. The method of claim 1, wherein the trained machine learning model and the unlearned model return the same label for the forget sample and its corresponding adversarial forget sample, and the unlearned model outputs an incorrect label for the forget sample and corresponding adversarial forget sample.

3. The method of claim 1, wherein a difference between the forget sample and the adversarial forget sample is less than a threshold.

4. The method of claim 1, wherein the random label is selected from a discrete uniform distribution of labels.

5. The method of claim 1, wherein the L2 norm comprises a square root of a sum of squares of a difference of all weights between the trained machine learning model and the unlearned model.

6. The method of claim 1, wherein the minimization is solved using stochastic gradient decent.

7. A system, comprising:
a database comprising a plurality of retain samples and a plurality of forget samples;
an electronic device comprising a computer processor executing an unlearning computer program; and
a downstream system in a production environment;
wherein:
the unlearning computer program receives the plurality of retain samples and the plurality of forget samples from the database;
the unlearning computer program computes an adversarial forget sample corresponding to each forget sample;
the unlearning computer program computes a first loss function term for each retain sample based on a corresponding retain sample label and a predicted retain sample label by an unlearned model;
the unlearning computer program computes a second loss function term for each forget sample based on a predicted label for its adversarial forget sample and a random label;
the unlearning computer program computes a L2 norm for a trained machine learning model and the unlearned model;
the unlearning computer program solves for a minimization of weights using the first loss function term, the second loss function term, and the L2 norm;
the unlearning computer program updates the unlearned model using weights resulting from the minimization; and
the unlearning computer program deploys the unlearned model to the downstream system in the production environment, where the unlearned model does not include information for the adversarial forget samples and maintains information from the retain samples.

8. The system of claim 7, wherein the trained machine learning model and the unlearned model return the same label for the forget sample and its corresponding adversarial forget sample, and the unlearned model outputs an incorrect label for the forget sample and corresponding adversarial forget sample.

9. The system of claim 7, wherein a difference between the forget sample and the adversarial forget sample is less than a threshold.

10. The system of claim 7, wherein the random label is selected from a discrete uniform distribution of labels.

11. The system of claim 7, wherein the L2 norm comprises a square root of a sum of squares of a difference of all weights between the trained machine learning model and the unlearned model.

12. The system of claim 7, wherein the minimization is solved using stochastic gradient decent.

13. A non-transitory computer readable storage medium, including instructions stored thereon, which when read and executed by one or more computer processors, cause the one or more computer processors to perform steps comprising:
receiving a plurality of retain samples and a plurality of forget samples to unlearn from a trained machine learning model;
computing an adversarial forget sample corresponding to each forget sample;
computing a first loss function term for each retain sample based on a corresponding retain sample label and a predicted retain sample label by an unlearned model;
computing a second loss function term for each forget sample based on a predicted label for its adversarial forget sample and a random label;
computing a L2 norm for the trained machine learning model and the unlearned model;
solving for a minimization of weights using the first loss function term, the second loss function term, and the L2 norm;
updating the unlearned model using weights resulting from the minimization; and
deploying the unlearned model to a production environment, where the unlearned model does not include information for the adversarial forget samples and maintains information from the retain samples.

14. The non-transitory computer readable storage medium of claim 13, wherein the trained machine learning model and the unlearned model return the same label for the forget sample and its corresponding adversarial forget sample, and the unlearned model outputs an incorrect label for the forget sample and corresponding adversarial forget sample.

15. The non-transitory computer readable storage medium of claim 13, wherein a difference between the forget sample and the adversarial forget sample is less than a threshold.

16. The non-transitory computer readable storage medium of claim 13, wherein the random label is selected from a discrete uniform distribution of labels.

17. The non-transitory computer readable storage medium of claim 13, wherein the L2 norm comprises a square root of a sum of squares of a difference of all weights between the trained machine learning model and the unlearned model.

18. The non-transitory computer readable storage medium of claim 13, wherein the minimization is solved using stochastic gradient decent.
